(19) United States
(12) Patent Application Publication
(10) Pub. No.: US 2022/0153295 A1
(43) Pub. Date: May 19, 2022

(54) OPERATION MANAGEMENT SYSTEM FOR AUTOMATIC TRAVELING VEHICLE

(71) Applicant: TOYOTA JIDOSHA KABUSHIKI KAISHA, Toyota-shi Aichi-ken (JP)

(72) Inventors: Saki Narita, Toyota-shi Aichi-ken (JP); Tetsuya Kanata, Susono-shi Shizuoka-ken (JP); Yozo Iwami, Susono-shi Shizuoka-ken (JP); Daisaku Honda, Nagoya-shi Aichi-ken (JP); Yuhei Katsumata, Fuji-shi Shizuoka-ken (JP); Hideki Fukudome, Toyota-shi Aichi-ken (JP); Takuya Watabe, Hachioji-shi Tokyo-to (JP); Naoko Ichikawa, Shibuya-ku Tokyo-to (JP); Yuta Maniwa, Susono-shi Shizuoka-ken (JP); Yuki Nishikawa, Susono-shi Shizuoka-ken (JP)

(21) Appl. No.: 17/527,583

(22) Filed: Nov. 16, 2021

(30) Foreign Application Priority Data
Nov. 18, 2020 (JP) 2020-191922

(51) Int. Cl. B60W 60/00; B60W 50/14

(52) U.S. Cl. CPC B60W 60/007; B60W 60/00253; B60W 60/00256; B60W 50/14; A47L 7/0085; B60W 2556/45; B60W 2420/42; B60W 2050/143; B60W 2420/54; B60W 60/00259

(57) ABSTRACT

An operation management system includes an automatic traveling vehicle and a management server. The vehicle includes a first processor, and is configured to transport at least one of people or luggage. The management server includes a second processor, and is configured to communicate with the vehicle and manage the operation thereof. The first processor or second processor is configured to: determine whether there is a transport task in which the vehicle transports at least one of people or luggage; and, when there is no transport task, execute a task switching process of causing the vehicle to execute any one of a patrol task in which the vehicle performs a patrol of an operating area of the vehicle, a cleaning task in which the vehicle performs a cleaning of the operating area, and a patrol cleaning task in which the vehicle performs both the patrol and the cleaning.

### CROSS-REFERENCE TO RELATED APPLICATION

The present disclosure claims priority under 35 U.S.C. § 119 to Japanese Patent Application No. 2020-191922, filed on Nov. 18, 2020, which is incorporated herein by reference in its entirety.

### BACKGROUND

### Technical Field

The present disclosure relates to an operation management system for an automatic traveling vehicle, and more particularly to an operation management system for an automatic traveling vehicle configured to transport at least one of people or luggage.

### Background Art

JP 2002-260126 A discloses a patrol support system using a mobile unmanned terminal. Specifically, in the patrol support system, the mobile unmanned terminal is arranged in an office, and is equipped with a monitor, a CPU, a measuring device, an ID reader, and a surveillance camera. A server for exchanging information with the mobile unmanned terminal is located inside or outside the office. The server is equipped with various databases, and is configured to allow the mobile unmanned terminal to monitor a monitored equipment in the office.

### SUMMARY

Automatic traveling vehicles can be configured for the purpose of transportation of people or luggage, patrol (for example, for a security purpose), or cleaning. A number of automatic traveling vehicles dedicated to each application according to the needs of each of these transportation, patrol, and cleaning may be prepared. However, this kind of method may require a large number of automatic traveling vehicles, and may reduce the operating rate of the automatic traveling vehicles during times when there is no or little need for a particular application. Therefore, the method is not efficient in the operation of automatic traveling vehicles.

The present disclosure has been made in view of the problem described above, and an object of the present disclosure is to provide an operation management system that enables efficient operation of one or more automatic traveling vehicles configured to transport at least one of people and luggage.

An operation management system according to the present disclosure includes an automatic traveling vehicle and a management server. The automatic traveling vehicle includes a first processor, and is configured to transport at least one of people or luggage. The management server includes a second processor, and is configured to communicate with the automatic traveling vehicle and manage an operation of the automatic traveling vehicle. The first processor or the second processor is configured to: determine whether or not there is a transport task in which the automatic traveling vehicle transports at least one of people or luggage; and, when there is no transport task, execute a task switching process of causing the automatic traveling vehicle to execute any one of a patrol task in which the automatic traveling vehicle performs a patrol of an operating area of the automatic traveling vehicle, a cleaning task in which the automatic traveling vehicle performs a cleaning of the operating area, and a patrol cleaning task in which the automatic traveling vehicle performs both the patrol and the cleaning.

In the task switching process, the first processor or the second processor may be configured to switch from the transport task to any one of the patrol task, the cleaning task, and the patrol cleaning task when a time zone without the transport task arrives.

In the task switching process, the first processor or the second processor may be configured to switch from the transport task to any one of the patrol task, the cleaning task, and the patrol cleaning task when a latest transport task has been completed and a next transport task has not been accepted.

The automatic traveling vehicle may include: an in-vehicle camera configured to photograph surroundings of the automatic traveling vehicle; an emergency button configured to be operated when an abnormal situation occurs around the automatic traveling vehicle; and a first alarm device. In the patrol task or the patrol cleaning task, the first processor may be configured to operate the first alarm device and execute at least one of recording an image photographed by the in-vehicle camera and transmitting the image to the management server when the emergency button is operated.

The automatic traveling vehicle may include: an emergency button configured to be operated when an abnormal situation occurs around the automatic traveling vehicle; and a position information acquisition device configured to acquire position information of the automatic traveling vehicle. The management server may be configured to communicate with a second alarm device installed in the operating area. In the patrol task or the patrol cleaning task, the first processor may be configured to transmit abnormality information indicating an occurrence of the abnormal situation and the position information to the management server when the emergency button is operated. The second processor may be configured to operate the second alarm device located around the automatic traveling vehicle when the management server receives the abnormality information and the position information.

The automatic traveling vehicle may include a microphone. In the patrol task or the patrol cleaning task, the first processor may be configured to determine that an abnormal situation has occurred around the automatic traveling vehicle when the first processor detects a predetermined password using the microphone.

The automatic traveling vehicle may include an in-vehicle camera configured to photograph surroundings of the automatic traveling vehicle. In the patrol task or the patrol cleaning task, the first processor may be configured to execute an abnormal situation determination process of determining whether or not an abnormal situation has occurred around the automatic traveling vehicle, based on an image photographed by the in-vehicle camera and learning data of images showing the abnormal situation.

The automatic traveling vehicle may include a first alarm device. The first processor may be configured to operate the first alarm device when the abnormal situation determination process determines that the abnormal situation has occurred.

The first processor may be configured, when the abnormal situation determined by the abnormal situation determination process indicates that there is a suspicious person around the automatic traveling vehicle, to: control travel of the automatic traveling vehicle so as to track the suspicious person; photograph the suspicious person using the in-vehicle camera; and execute at least one of recording a photographed image of the suspicious person and transmitting the photographed image to the management server.

The automatic traveling vehicle may include a position information acquisition device configured to acquire position information of the automatic traveling vehicle. The first processor may be configured, when the abnormal situation determined by the abnormal situation determination process indicates that there is a suspicious person around the automatic traveling vehicle, to transmit the position information to the management server and request the management server to dispatch a person to a place where the abnormal situation has occurred.

The automatic traveling vehicle or the management server may be configured to communicate with a plurality of illuminance sensors installed in the operating area. The first processor or the second processor may be configured, when executing the patrol task or the patrol cleaning task in a nighttime, to generate a patrol route such that the automatic traveling vehicle sequentially passes through a plurality of patrol spots with low illuminance in the operating area.

The automatic traveling vehicle or the management server may be configured to communicate with a plurality of infrastructure cameras installed in the operating area. The first processor or the second processor may be configured to: identify, using the plurality of infrastructure cameras, a plurality of spots with low traffic density in the operating area in a patrol time zone in which the patrol task or the patrol cleaning task is executed; and generate a patrol route such that the automatic traveling vehicle sequentially passes through the plurality of spots when executing the patrol task or the patrol cleaning task in the patrol time zone.

The first processor or the second processor may be configured to randomly generate a patrol route so as to become different each time the patrol task or the patrol cleaning task is executed.

The automatic traveling vehicle or the management server may be configured to communicate with a plurality of other vehicles, which are other than the automatic traveling vehicle and travel the operating area. The first processor or the second processor may be configured to: acquire operation information of the plurality of other vehicles; and generate, based on the operation information, a patrol route such that the automatic traveling vehicle sequentially passes through a plurality of patrol spots with low density of vehicles traveling in the operating area.

The automatic traveling vehicle may include: a cleaning request button configured to be operated by a user on board; and a position information acquisition device configured to acquire position information of the automatic traveling vehicle. The first processor may be configured to transmit, to the management server, information on a cleaning request position, which is a position of the automatic traveling vehicle when the cleaning request button is operated by the user, when the automatic traveling vehicle is executing the transport task in a daytime. The second processor may be configured to give the cleaning task or the patrol cleaning task to the automatic traveling vehicle or another traveling vehicle having a same configuration as the automatic traveling vehicle to perform a cleaning of the cleaning request position in a nighttime.

The automatic traveling vehicle or the management server may be configured to communicate with a plurality of infrastructure cameras installed in the operating area. The first processor or the second processor may be configured to: identify and record, using the plurality of infrastructure cameras, one or more cleaning spots with high people traffic density in a daytime in the operating area; and generate a cleaning route such that the automatic traveling vehicle passes through the one or more cleaning spots when the automatic traveling vehicle performs the cleaning task or the patrol cleaning task in a nighttime.

The automatic traveling vehicle may include a position information acquisition device configured to acquire position information of the automatic traveling vehicle. The second processor may be configured to: record a position of a cleaning execution spot identified by the position information acquisition device each time the automatic traveling vehicle or another traveling vehicle having a same configuration as the automatic traveling vehicle performs a cleaning in the cleaning task or the patrol cleaning task; and generate, based on position data of recorded cleaning execution spots, a cleaning route such that the automatic traveling vehicle or the another automatic traveling vehicle sequentially passes through a plurality of cleaning spots where cleaning is frequently performed in the operating area.

According to the operation management system of the present disclosure, the automatic traveling vehicle not only performs the transport task, but also performs any one of the patrol task, the cleaning task, and the patrol cleaning task, which are other types of tasks, when there is no transport task. This makes it possible to efficiently operate the automatic traveling vehicle while reducing the number of automatic traveling vehicles prepared for the provision of a transport service and other services (i.e., patrol service, cleaning service or both).

### BRIEF DESCRIPTION OF THE DRAWINGS

FIG. 1 is a perspective view showing an example of a configuration of an automatic traveling vehicle according to a first embodiment;

FIG. 2 is a diagram showing a configuration example of a chassis unit shown in FIG. 1;

FIG. 3 is a block diagram schematically showing an example of a configuration of a control system for controlling the travel of the automatic traveling vehicle shown in FIG. 1;

FIG. 4 is a block diagram schematically showing a configuration of an operation management system according to the first embodiment;

FIG. 5 is a flowchart showing an example of a task switching process according to the first embodiment;

FIG. 6 is a flowchart showing a modified example of the task switching process according to the first embodiment;

FIG. 7 is a flowchart showing another modified example of the task switching process according to the first embodiment;

FIG. 8 is a perspective view showing a modified example of the configuration of the automatic traveling vehicle according to the first embodiment;

FIG. 9 is a flowchart showing still another modified example of the task switching process according to the first embodiment;

FIG. 10 is a flowchart showing an example of processing related to response to an abnormal situation during a patrol task according to a second embodiment;

FIG. 11 is a flowchart showing a modified example of processing related to response to an abnormal situation during the patrol task according to the second embodiment;

FIG. 12 is a flowchart showing the modified example of processing related to response to an abnormal situation during the patrol task according to the second embodiment;

FIG. 13 is a flowchart showing another modified example of processing related to response to an abnormal situation during the patrol task according to the second embodiment;

FIG. 14 is a flowchart showing an example of processing related to response to an abnormal situation during the patrol task according to a third embodiment;

FIG. 15 is a flowchart showing a modified example of processing related to response to an abnormal situation during the patrol task according to the third embodiment;

FIG. 16 is a flowchart showing another modified example of processing related to response to an abnormal situation during the patrol task according to the third embodiment;

FIG. 17 is a flowchart showing an example of processing related to the generation of a patrol route according to a fourth embodiment;

FIG. 18 is a flowchart showing a modified example of processing related to the generation of the patrol route according to the fourth embodiment;

FIG. 19 is a flowchart showing another modified example of processing related to the generation of the patrol route according to the fourth embodiment;

FIG. 20 is a flowchart showing still another modified example of processing related to the generation of the patrol route according to the fourth embodiment;

FIG. 21A is a flowchart showing an example of processing executed during execution of a transport task in the daytime according to a fifth embodiment;

FIG. 21B is a flowchart showing an example of processing related to setting a cleaning task in the nighttime according to the fifth embodiment;

FIG. 22 is a flowchart showing an example of processing related to the generation of the cleaning route according to a sixth embodiment;

FIG. 23A is a flowchart showing a modified example of processing related to the generation of the cleaning route according to the sixth embodiment; and

FIG. 23B is a flowchart showing the modified examples of processing related to the generation of the cleaning route according to the sixth embodiment.

### DETAILED DESCRIPTION

In the following embodiments of the present disclosure, the same components in the drawings are denoted by the same reference numerals, and redundant descriptions thereof are omitted or simplified. Moreover, it is to be understood that even when the number, quantity, amount, range or other numerical attribute of an element is mentioned in the following description of the embodiments, the present disclosure is not limited to the mentioned numerical attribute unless explicitly described otherwise, or unless the present disclosure is explicitly specified by the numerical attribute theoretically.

### 1. First Embodiment

### 1-1. Configuration Example of Automatic Traveling Vehicle

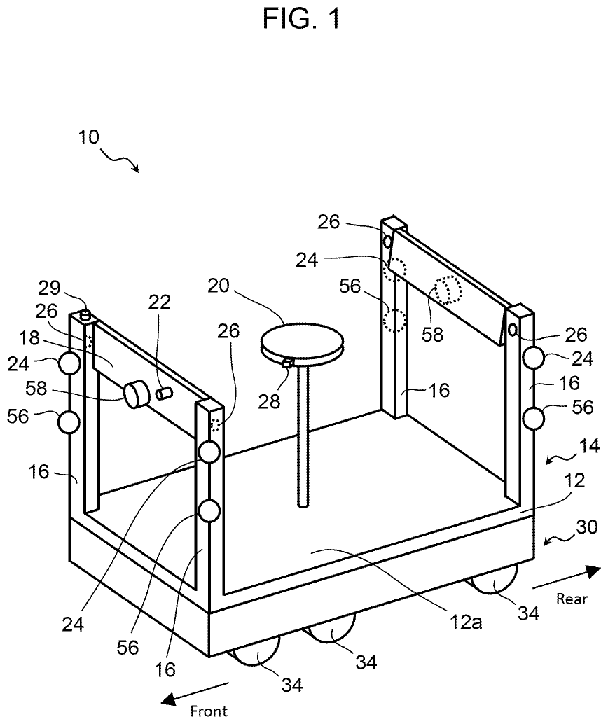

FIG. 1 is a perspective view showing an example of the configuration of an automatic traveling vehicle according to a first embodiment. The automatic traveling vehicle 10 shown in FIG. 1 is configured to be unmanned as described below. Also, the “automatic traveling vehicle” according to the present disclosure is a transport vehicle configured to transport at least one of people and luggage. As an example, the automatic traveling vehicle 10 is configured to transport people.

Specifically, the automatic traveling vehicle 10 is provided with a top plate 12 having an upper surface (riding surface) 12a configured for a user to ride on. The riding capacity when this kind of automatic traveling vehicle 10 is used to transport people is not particularly limited, but is, for example, four people. That is, the automatic traveling vehicle 10 is a small automatic traveling vehicle (cart).

The automatic traveling vehicle (hereinafter, simply referred to as “vehicle”) 10 is configured by a vehicle body 14 including the top plate 12, and the following chassis unit 30 that is a component relating to the traveling function. Unlike the example of the automatic traveling vehicle 10, the “automatic traveling vehicle” according to the present disclosure may be configured to transport luggage instead of or with people. The automatic traveling vehicle with specifications for transporting luggage can also be configured by, for example, using the chassis unit 30 and replacing the vehicle body 14 for transporting people with a vehicle body for transporting luggage.

Then, an example of the configuration of the vehicle body 14 will be described. In the vehicle 10, the configuration of the riding space positioned on the top plate 12 can be freely selected. As an example, a support 16 is provided at each of the four corners of the riding surface 12a. A backrest 18 is provided at each of the front end and the rear end of the vehicle 10. The backrest 18 is fixed using two supports 16. A table 20 convenient for the user is attached to the center of the riding surface 12a.

Moreover, the vehicle 10 includes a buzzer 22, an abnormality warning lamp 24, an emergency button (push button) 26, a microphone 28, and a cleaning request button 29. The buzzer 22 is provided, for example, on the back surface of the backrest 18 on the vehicle front side. The abnormality warning lamp 24 is installed on each of the four supports 16, for example. The emergency button 26 is operated when an abnormal situation occurs around the vehicle 10, and is installed on each of the four supports 16, for example. The microphone 28 is installed on, for example, the table 20 in order to pick up the voice of the riding space of the vehicle 10. The buzzer 22, the abnormality warning lamp 24, the emergency button 26, and the microphone 28 are used in a second embodiment described below. The cleaning request button 29 is used in a fifth embodiment described below. The buzzer 22, the abnormality warning lamp 24, the emergency button 26, the microphone 28, and the cleaning request button 29 are connected to an automatic travel ECU 64 described below.

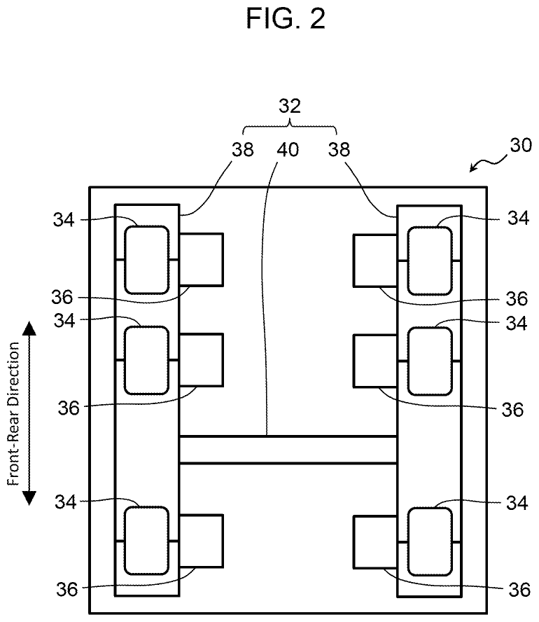

Then, FIG. 2 is referenced in addition to FIG. 1. FIG. 2 is a diagram showing a configuration example of the chassis unit 30 shown in FIG. 1.

The chassis unit 30 includes a frame 32, wheels 34, and electric motors 36. As an example, six wheels 34 are provided. More specifically, three wheels 34 are disposed on each of the left and right sides of the vehicle 10 in a bilaterally symmetrical manner. The electric motor 36 is provided, for example, coaxially with each of the six wheels 34. It should be noted that the number of the wheels 34 is arbitrarily determined in accordance with requirements such as the riding capacity of the vehicle 10 and the required driving force thereof. Instead of six, for example, a total of four wheels, i.e., two wheels on the left and two wheels on the right, may be used. Further, the number of the electric motors 36 does not necessarily have to be the same as the number of the wheels 34, and may be changed according to requirements such as the required driving force.

FIG. 2 shows a schematic shape of the frame 32. The frame 32 includes a main member 38 extending in the front-rear direction of the vehicle 10 on each of the left and right sides of the vehicle 10, and a sub-member 40 connecting the two main members 38. Three left wheels 34 and three electric motors 36 for driving them are fixed to the main member 38 on the left of the vehicle 10. Similarly, three right wheels 34 and three electric motors 36 for driving them are fixed to the main member 38 on the right of the vehicle 10.

Acceleration and deceleration of the vehicle 10 are performed by controlling the electric motors 36. Further, the vehicle 10 can be braked, for example, by using a regenerative brake realized by the control of the electric motors 36. The vehicle 10 may be provided with a mechanical brake on any wheel 34 for braking.

Moreover, according to the vehicle 10 including the above-described chassis unit 30, by providing a difference between the rotational speeds of the three wheels 34 on the left side and the rotational speeds of the three wheels 34 on the right side, the vehicle 10 can be turned to the left and right. In the example shown in FIG. 2, each wheel 34 is a wheel having a general structure in which a tire is incorporated. Instead of this kind of example, in order to increase the degree of freedom of turning of the vehicle 10, for example, the four wheels 34 positioned at both ends in the front-rear direction may be replaced by omnidirectional moving wheels (so-called omni wheels). Furthermore, instead of these examples, for example, a steering apparatus may be used to turn the vehicle 10.

In addition, although the vehicle 10 according to the first embodiment is a wheeled vehicle including the wheels 34, the automatic traveling vehicle according to the present disclosure is not limited to this, and may be configured as a tracked vehicle having an infinite track.

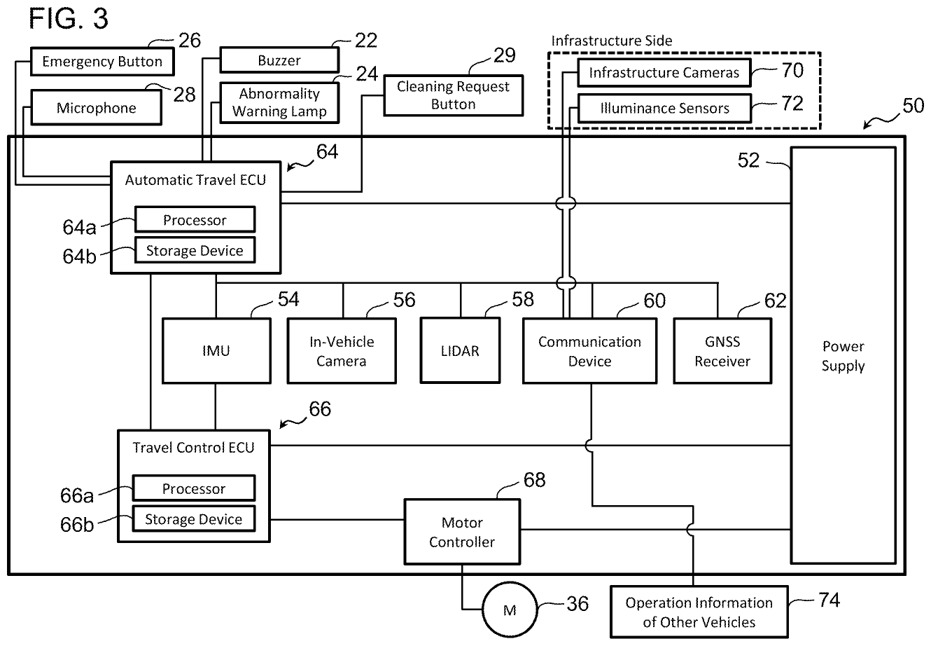

Then, FIG. 3 is a block diagram schematically showing an example of the configuration of a control system 50 for controlling the travel of the automatic traveling vehicle 10 shown in FIG. 1. The control system 50 is mounted on the automatic traveling vehicle 10. The control system 50 is configured to cause the vehicle 10 to automatically travel.

As shown in FIG. 3, the control system 50 includes a power storage device 52, an inertial measurement unit (IMU) 54, in-vehicle cameras (simply also referred to as “cameras”) 56, LIDARs (laser imaging detection and ranging) 58, a communication device 60, a global navigation satellite system (GNSS) receiver 62, an automatic travel electronic control unit (ECU) 64, a travel control ECU 66, and a motor controller 68. As shown in FIG. 1, the camera 56 is installed on each of the four supports 16, and the LIDAR 58 is installed on the back surface of each of the two backrests 18. The components 52, 54, 60 to 68 of the control system 50 other than the cameras 56 and the LIDARs 58 are disposed, for example, between the frame 32 and the top plate 12.

The power storage device 52 is a secondary battery, such as a lithium ion battery, a capacitor, or both. The power storage device 52 supplies electric power to each device (the electric motors 36 and the control system 50) mounted on the vehicle 10. The power storage device 52 also supplies electric power to the buzzer 22, the abnormality warning lamp 24, the emergency button 26, and the cleaning request button 29 via the automatic travel ECU 64. The IMU 54 detects angular velocities and accelerations of three axes. Therefore, according to the IMU 54, it is possible to acquire various traveling states such as the speed (i.e., vehicle speed), the acceleration, and the posture of the vehicle 10. The IMU 54 transmits the acquired traveling states to the automatic travel ECU 64 and the travel control ECU 66.

The cameras 56 and the LIDARs 58 are examples of “external sensor” for recognizing the surrounding environment of the vehicle 10. The four cameras (outward facing cameras) 56 photograph the surroundings of the vehicle 10 (more specifically, the front right, front left, rear right, and rear left of the vehicle 10). The two LIDARs 58 respectively detect objects in front of and behind the vehicle 10. According to the LIDAR 58, the distance and the direction of the detected object from the vehicle 10 can be acquired. The cameras 56 and the LIDARs 58 transmit the acquired information to the automatic travel ECU 64. Additionally, instead of the example shown in FIG. 3, only one of the camera 56 and the LIDAR 58 may be used.

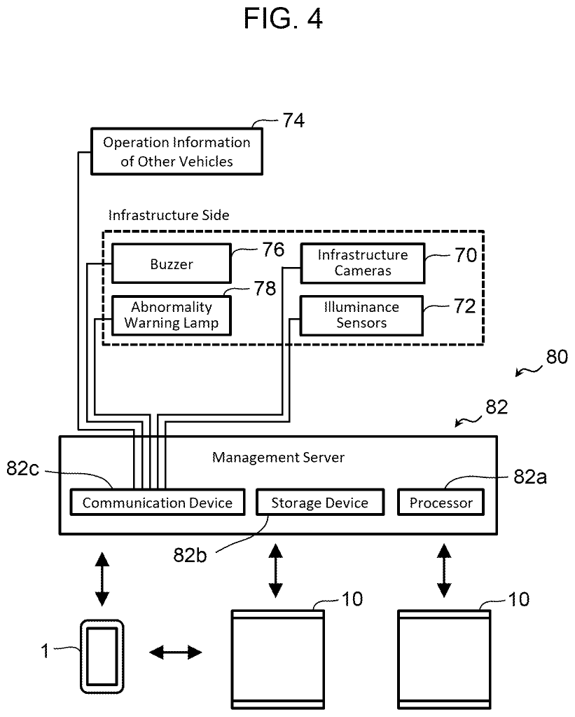

The communication device 60 performs communication (transmission and reception) with a communication device 82c of a management server 82 (see FIG. 4), which will be described later, via a wireless communication network such as 4G or 5G. Also, the communication device 60 communicates with a mobile terminal 1 (see FIG. 4), which will be described later, via a similar wireless communication network. The GNSS receiver 62 acquires the position and orientation of the vehicle 10 based on signals from GNSS satellites. The GNSS receiver 62 transmits the acquired information to the automatic travel ECU 64. In addition, the GNSS receiver 62 corresponds to an example of the “position information acquisition device” according to the present disclosure.

The automatic travel ECU 64 includes a processor 64a and a storage device 64b. The storage device 64b stores at least one program configured to cause the vehicle 10 to automatically travel. When the processor 64a reads and executes a program stored in the storage device 64b, various kinds of processing performed by the processor 64a are realized. Also, the storage device 64b stores map information as a map database. Alternatively, the processor 64a may acquire the map information from a map database stored in a storage device 82b (see FIG. 4) of the management server 82.

In an example of a use of the vehicle 10 (an example of executing a transport task to transport people using a vehicle dispatch service described below), the destination is transmitted from the mobile terminal 1 of the user to the automatic travel ECU 64 via the management server 82. The automatic travel ECU 64 (processor 64a) sets a target travel route from the current location of the vehicle 10 to the destination and a target vehicle speed, on the basic of the position information of the vehicle 10 from the GNSS receiver 62 and the map information of the map database. In addition, the processor 64a changes (updates) the set target travel route and the set basic target vehicle speed as necessary on the basis of the traveling state information and the position information of the vehicle 10 based on the IMU 54 and the GNSS receiver 62, and the information of the objects around the vehicle 10 acquired by the cameras 56 and the LIDARs 58.

The automatic travel ECU 64 transmits the latest target travel route and the final target vehicle speed to the travel control ECU 66. The travel control ECU 66 includes a processor 66a and a storage device 66b. The storage device 66b stores various kinds of information necessary for the control of each electric motor 36 to cause the vehicle 10 to automatically travel. The processor 66a generates a control command value (more specifically, a command value such as a rotational speed and a rotation direction) of each electric motor 36 for causing the vehicle 10 to travel so as to achieve the target travel route and the target vehicle speed. The processor 66a uses the information indicating the traveling state acquired by the IMU 54 to generate the control command value.

The travel control ECU 66 commands the generated control command value of each electric motor 36 to each motor controller 68. The motor controller 68 includes a drive circuit configured to control electric power supplied to the electric motors 36 from the power storage device 52, and is provided for each of the six electric motors 36. Each motor controller 68 controls energization to each electric motor 36 according to the control command value from the travel control ECU 66.

According to the control by the automatic travel ECU 64 and the travel control ECU 66 described above, the vehicle 10 can automatically travel toward the destination.

Furthermore, a plurality of infrastructure cameras 70 and a plurality of illuminance sensors 72 are densely installed along the roadside in an operating are of the automatic traveling vehicle 10. Each of the infrastructure cameras 70 photographs the road on which the vehicle 10 travels and its surroundings. Each of the illuminance sensors 72 detects the brightness around the place where the illuminance sensor 72 is installed. The communication device 60 of the automatic travel ECU 64 can communicates with these infrastructural cameras 70 and the illuminance sensors 72 via a communication device (not shown) installed along the roadside. In addition, the communication device 60 can communicate with a plurality of other vehicles (e.g., other automatic traveling vehicles (including one or more vehicles having the same configuration as the automatic traveling vehicle 10) and taxis) that each includes a communication device, and can acquire the operation information (e.g., position information and traffic jam information) 74 of the plurality of other vehicles.

### 1-2. Configuration Example of Operation Management System for Automatic Traveling Vehicle

FIG. 4 is a block diagram schematically showing a configuration of an operation management system 80 according to the first embodiment. The “automatic traveling vehicle” according to the present disclosure such as the vehicle 10 configured as described above is available for the provision of various transportation services for the movement of people or the transportation of luggage. In order to provide these kinds of various transportation services, the operation management system 80 manages the operation of a plurality of vehicles 10.

The operation management of the vehicle 10 is planned, for example, such that the vehicle 10 travels in a predetermined operating area. In addition, the road on which the vehicle 10 travels is not particularly limited, but in the transportation service, each vehicle 10 automatically travels, for example, on a road in which a plurality of vehicles 10 whose operation is controlled coexist with pedestrians. Furthermore, in the example of the transportation service for people, the service will be more convenient if it is provided with a vehicle dispatch service that dispatches the vehicle 10 in response to a request from the user.

The operation management system 80 includes a mobile terminal 1, and a management server 82 in addition to a plurality of vehicles 10. The mobile terminal 1 is carried by the user of the vehicle 10 and is, for example, a smartphone or a tablet personal computer. The mobile terminal 1 includes a processor, a storage device, and a communication device.

The management server 82 includes a processor 82a, a storage device 82b, and a communication device 82c. The storage device 82b stores at least one program for various transportation services. The processor 82a reads and executes a program stored in the storage device 82b. Accordingly, various functions for providing the various services are realized. For example, the management server 82 (communication device 82c) communicates with the communication device 60 of each vehicle 10 and the mobile terminal 1 via a wireless communication network. The management server 82 manages user information. Further, the operation management of the plurality of vehicles 10 by the management server 82 may include, for example, a remote operation of the vehicle 10 in an emergency by an operator via the management server 82.

Furthermore, the communication device 82c of the management server 82 can communicate with not only the plurality of infrastructure cameras 70 and the plurality of illuminance sensors 72 described above, but also one or more buzzers 76 and one or more abnormality warning lamps 78 via a communication device (not shown) installed along the roadside. The buzzers 76 and the abnormality warning lamps 78 are incorporated in, for example, pillars arranged along the roadside in the operating area. Furthermore, the communication device 82c can communicate with a plurality of other vehicles in the same manner as the communication device 60 of the vehicle 10, and can acquire operation information (e.g., position information and congestion information) 74 of the plurality of other vehicles.

### 1-3. Task Management of Automatic Traveling Vehicle (Task Switching Process)

The tasks performed by the automatic traveling vehicle 10 in the first embodiment are a transport task and a patrol task.

The transport task is a task in which the vehicle 10 transports a person, and is executed during the execution of the transport service described above. In an example in which an automatic traveling vehicle transports luggage, the transport task is a task of transporting luggage. The transport task typically occurs as follows. That is, in the example involving the vehicle dispatch service described above, the transport task occurs in response to a command from the management server 82 to the vehicle 10. Specifically, when a user who wishes to dispatch the vehicle 10 operates the mobile terminal 1 to make a vehicle dispatch reservation, the management server 82 selects the vehicle 10 to be dispatched and transmits the vehicle dispatch reservation information to the selected vehicle 10. When the vehicle 10 receives this vehicle dispatch reservation information, a transport task occurs (i.e., the vehicle 10 accepts the transport task). In other words, the management server 82 gives a transport task to the vehicle 10. Also, the transport task is typically completed as follows. That is, the transport task is completed when the vehicle 10 transporting the user arrives at the destination and the user gets off the vehicle 10. It should be noted that the vehicle 10 may additionally monitor the operating area for the same security purpose as the following patrol task during the execution of the transport task.

On the other hand, the patrol task is a task in which the vehicle 10 performs patrol of a predetermined operating area of the vehicle 10. The patrol by the vehicle 10 is typically performed for security purposes. The vehicle 10 is equipped with the cameras 56 for automatic traveling. The cameras 56 are also used for patrol security in the patrol task. However, a dedicated camera other than the cameras 56 for automatic traveling may be used for the execution of the patrol task. The vehicle 10 basically executes a patrol task by traveling on a predetermined patrol route in a scheduled time zone in accordance with a command from the management server 82. In addition, the method for generating a characteristic patrol route will be described in the following fourth embodiment.

In the patrol task, the processor 64a transmits, for example, an image of the surroundings of the vehicle 10 captured by each camera 56, to the management server 82. The images of the cameras 56 transmitted to the management server 82 are used, for example, by an observer of a management facility in which the management server 82 is installed to determine the presence or absence of an abnormal situation. Examples of other specific security contents in the patrol task will be described below in second and third embodiments.

With respect to these transport service and patrol service, the time zones when there are many needs are not always the same. More specifically, for example, it is expected that there will be many needs for transportation for the purpose of commuting to work and school in the morning and evening hours, and there will be many needs for the purpose of taking a walk in the daytime. On the other hand, it is expected that the needs for patrols will increase, for example, at night when there is little people traffic. In spite of the fact that the time zones when the needs increase are different, it is not efficient in the operation of the vehicle 10 to prepare the number of the vehicles 10 that performs only the transport task and the number of the vehicles 10 that performs only the patrol task in order to satisfy the respective needs. The reason is that the operating rate of the vehicle 10 decreases in a time zone in which there is no need or there is little need.

Therefore, in the first embodiment, it is determined whether or not there is a transport task while the vehicle 10 is traveling. As a result, when there is no transport task, a “task switching process” for causing the vehicle 10 to perform the patrol task is executed.

More specifically, in the first embodiment, the task switching process is executed as follows as an example. That is, in the first embodiment, a time zone TZ1 in which the vehicle 10 performs the transport task and a time zone TZ2 in which the vehicle 10 performs the patrol task are determined in advance. The time zone TZ1 is defined as, for example, the daytime (a predetermined time period from morning to evening (for example, from 7:00 am to 6:00 pm)) in which there are many needs for transportation services. On the other hand, the time zone TZ2 is defined as, for example, the nighttime (for example, from 6:00 pm to 12:00 pm) in which there is no or little need for transportation services. Then, in the task switching process, when the time zone in which there is no transport task (i.e., the time zone TZ2 in which the patrol task is performed) arrives while the vehicle 10 is traveling, the transport task is switched to the patrol task.

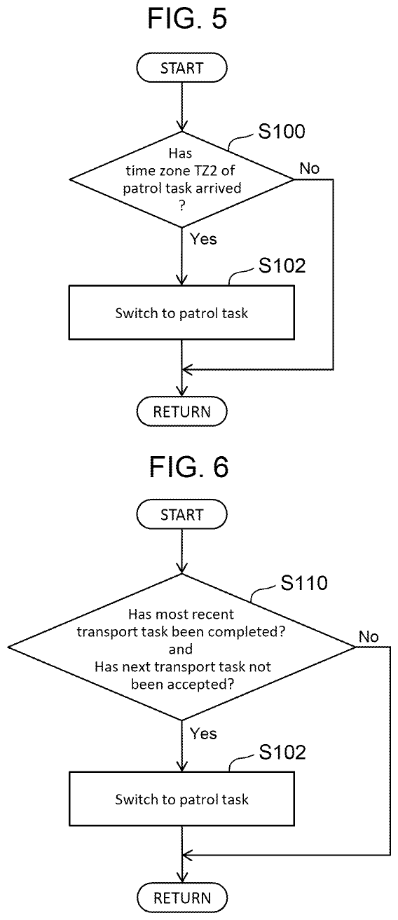

FIG. 5 is a flowchart showing an example of the task switching process according to the first embodiment. The processing of this flowchart is repeatedly executed by the processor 64a of the automatic travel ECU 64 in the time zone TZ1 in which the vehicle 10 is performing the transport task. The processor 64a corresponds to an example of the “first processor” according to the present disclosure.

In FIG. 5, first, in step S100, the processor 64a determines whether or not the time zone TZ2 in which the patrol task is performed (that is, the time zone in which there is no transport task) has arrived. As a result, when the time zone TZ2 has not yet arrived, the processor 64a ends the current processing cycle. In addition, in the processing of this flowchart, it is determined whether or not there is the transport task based on whether it is the time zone TZ1 with the transport task or a time zone without the transport task. Therefore, in this example, the time zone TZ1 with the transport task corresponds to when there is the transport task, and a time zone without the transport task corresponds to when there is no transport task.

On the other hand, when the time zone TZ2 arrives in step S100, the processing proceeds to step S102. In step S102, the processor 64a switches to the patrol task (that is, executes the task switching process described above).

### 1-4. Effect

As described above, in the first embodiment, the automatic traveling vehicle 10 performs not only the transport task, but also the patrol task, which is another type of task, when there is no transport task. This makes it possible to efficiently operate the automatic traveling vehicle 10 while reducing the number of automatic traveling vehicles 10 prepared for providing the transportation service and the patrol service.

More specifically, in the first embodiment, the automatic traveling vehicle 10 performs not only the transport task, but also the patrol task when the time zone TZ1 for performing the transport task ends and the time zone TZ2 for performing the patrol task arrives. As just described, by switching the tasks of the same vehicle 10 by paying attention to the fact that the time zones in which the needs of the transportation service and the patrol service increase are different, the transport task and the patrol task can be efficiently performed using a limited number of automatic traveling vehicles 10.

### 1-5. Other Execution Examples of Task Switching Process

1-5-1. Another Example of Determining that there is No Transport Task

FIG. 6 is a flowchart showing a modified example of the task switching process according to the first embodiment. The processing of this flowchart is repeatedly executed by the processor 64a while the vehicle 10 is performing the transport task.

In FIG. 6, first, in step S110, the processor 64a determines whether or not the most recent transport task has been completed and the next transport task has not been accepted. The processor 64a can determine that the most recent transport task has been completed, for example, when the vehicle 10 reaches the destination and completes a predetermined drop-off confirmation process to confirm that the user has been dropped off. This also applies to an example of transporting luggage, and the processor 64a can determine that the most recent transport task has been completed when the vehicle 10 reaches the destination and completes a predetermined process to confirm that the luggage has been dropped off from the vehicle 10.

When, in step S110, the most recent transport task has not been completed, or when this task has been completed but has already accepted the next transport task, the processor 64a ends the current processing cycle (that is, the processor 64a does not execute the task switching process).

On the other hand, when the determination result of step S100 is positive, the processing proceeds to step S102, and the switching to the patrol task is executed (that is, the task switching process is executed).

According to the example of the task switching process shown in FIG. 6 described above, when the transport task is not executed on the condition that the next transport task is not accepted, the switching to the patrol task is promptly executed. If this kind of switching to the patrol task is not executed, the vehicle 10 will temporarily return to a predetermined standby place or storage place when the most recent transport task is completed. As a result, useless traveling occurs without performing any task. In this regard, according to the example shown in FIG. 6, it is possible to efficiently operate the automatic traveling vehicle 10 while avoiding this kind of useless traveling.

### 1-5-2. Examples Executed by Processor on Management Server Side

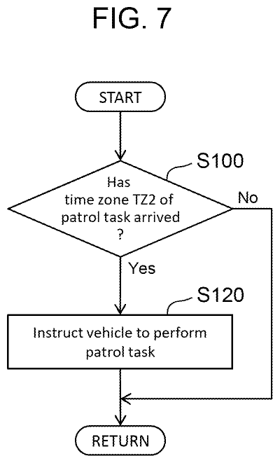

FIG. 7 is a flowchart showing another modified example of the task switching process according to the first embodiment. The processing of this flowchart is repeatedly executed by the processor 82a of the management server 82 in the time zone TZ1 in which the vehicle 10 is performing the transport task. The processor 82a corresponds to an example of the “second processor” according to the present disclosure.

In FIG. 7, first, in step S100, the processor 82a determines whether or not the time zone TZ2 in which the vehicle 10 performs the patrol task has arrived. As a result, when the time zone TZ2 has arrived, the processing proceeds to step S120. In step S120, the processor 82a instructs the vehicle 10 to switch to the patrol task (i.e., the processor 82a executes the task switching process).

As in the example shown in FIG. 7, the task switching of the vehicle 10 may be performed by the management server 82. Moreover, in order to execute the task switching process, the processor 82a of the management server 82 may execute the processing of step S110 (see FIG. 6) instead of the processing of step S100. Specifically, for example, when the vehicle 10 completes the transport task, the management server 82 may receive, from the vehicle 10, information indicating that the transport task has been completed. The processor 82a may then determine that the most recent transport task of the vehicle 10 has been completed upon receiving the information. Furthermore, the processor 82a may determine, for example, whether or not the vehicle 10 has not yet accepted the next transport task based on the transmission history of the vehicle dispatch reservation information from the management server 82 to the vehicle 10.

1-5-3. Examples of Switching from Transport Task to Cleaning Task (or Patrol Cleaning Task)

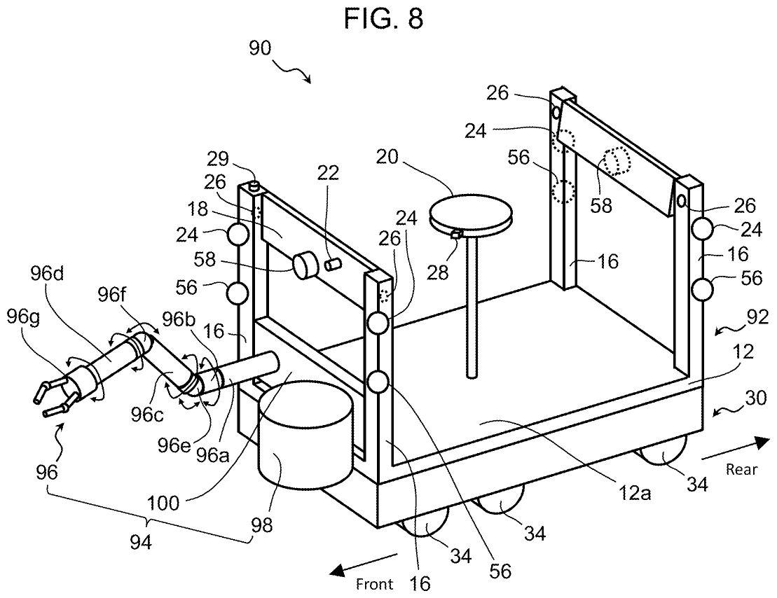

FIG. 8 is a perspective view showing a modified example of the configuration of the automatic traveling vehicle according to the first embodiment. An automatic traveling vehicle 90 shown in FIG. 8 is different from the automatic traveling vehicle 10 shown in FIG. 1 in that the vehicle 90 additionally includes a cleaning function.

Specifically, in this example, the processor 64a executes a “cleaning task” for cleaning the operating area (mainly the road) of the vehicle 90 together with the transport task. In order to perform this cleaning task, a vehicle body 92 of the vehicle 90 is provided with a cleaning device 94. The cleaning device 94 is arranged, for example, at a portion of the vehicle 90 on the front side as in the example shown in FIG. 8. The cleaning device 94 includes a collection arm 96 for collecting litter such as empty cans, a collection bag 98 for storing the collected litter, and a fixing member 100 for fixing the collection arm 96 and the collection bag 98. The fixing member 100 is formed in a plate shape, for example, and is attached to the two supports 16 on the vehicle front side.

The collection arm 96 includes a fixing portion 96a fixed to the fixing member 100, three links 96b, 96c, and 96d, two joints 96e and 96f, and a hand 96g. The hand 96g is located at the distal end of the collection arm 96, and can pick up the litter. These seven arm components 96a to 96g are rotatably or bendably connected to each other as indicated by arrows in FIG. 8. Also, an actuator (e.g., an electric motor) which is not shown is installed in each of six arm components 96b to 96g of these. These actuators are connected to the automatic travel ECU 64 (or a dedicated ECU).

The collection arm 96 configured as described above can rotate or bend the respective connecting portions of the arm components 96a to 96g in accordance with a command from the processor 64a of the automatic travel ECU 64. Thus, the collection arm 96 is capable of controlling the position of the hand 96g with respect to the vehicle 90 with a high degree of freedom. When collecting the litter, the processor 64a includes a process of automatically driving the vehicle 90 toward a position where the collection arm 96 reaches the litter using, for example, the cameras 56. Then, the processor 64a controls the position of the hand 96g so as to match the position of the litter using, for example, the cameras 56, then controls the hand 96g so as to pick up the litter, and then controls the collection arm 96 so as to store the picked up litter in the collection bag 98. This makes it possible to collect the litter.

Additionally, the cleaning device may be provided with, for example, a vacuum device capable of sucking and collecting litter or dust, instead of or together with the example of using the collection arm 96. The vacuum device may also be accompanied by, for example, a brush for cleaning the road surface.

Since the cleaning service of the operating area (mainly the road) of the vehicle 90 will obstruct the traffic of people in the daytime, it is expected that the needs will increase in the nighttime when the people traffic is low, similarly to the patrol service described above. Therefore, in the example described here, a time zone TZ3 in which the vehicle 90 performs the cleaning tasks is defined as, for example, a nighttime (e.g., from 6:00 pm to 12:00 pm) when there is no or little need for the transportation service. Furthermore, the vehicle 90 basically performs the cleaning task by traveling on a predetermined cleaning route in the time zone TZ3 in accordance with a command from the management server 82. In addition, a method of generating a characteristic cleaning route will be described below in a sixth embodiment.

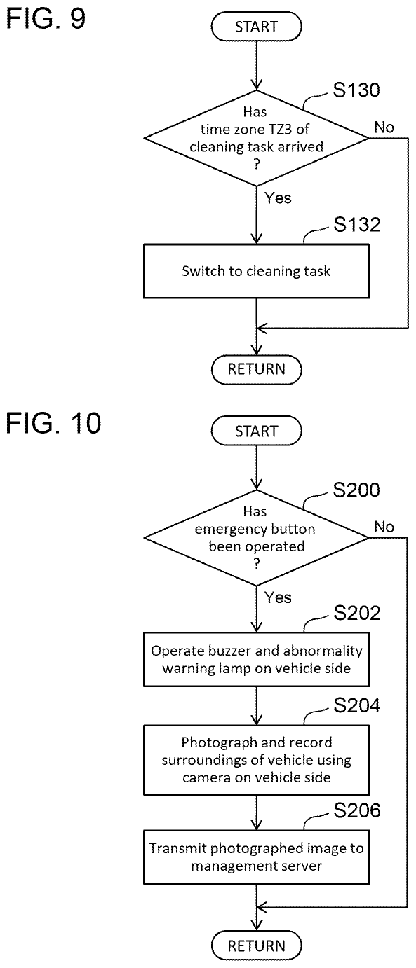

FIG. 9 is a flowchart showing still another modified example of the task switching process according to the first embodiment. The processing of this flowchart is repeatedly executed by the processor 64a during the period in which the vehicle 10 is performing the transport task.

In FIG. 9, first, in step S130, the processor 64a determines whether or not the time zone TZ3 for performing the cleaning task has arrived. As a result, when the time zone TZ3 has not yet arrived, the processor 64a ends the current processing cycle.

On the other hand, when the time zone TZ3 has arrived in step S130, the processing proceeds to step S132. In step S132, the processor 64a executes the switching to the cleaning task (that is, the processor 64a executes the task switching process).

As described above, according to the example shown in FIG. 9, the automatic traveling vehicle 90 performs not only the transport task but also the cleaning task which is another type of task when there is no transport task. This makes it possible to efficiently operate the automatic traveling vehicle 90 while reducing the number of automatic traveling vehicles 90 prepared for providing the transportation service and the cleaning service.

Moreover, the switching from the transport task to the cleaning task may be executed together with the processing of step S110 (see FIG. 6) instead of the processing of step S130. The switching may also be performed by the processor 82a of the management server 82, similarly to the example shown in FIG. 7.

Furthermore, since the automatic traveling vehicle 90 shown in FIG. 8 has the same basic configuration as the automatic traveling vehicle 10, the vehicle 90 can execute not only the transport task and the cleaning task but also the patrol task described above. Therefore, the vehicle 90 can also perform cleaning work while patrolling. Therefore, in another example of the task switching process, using the same method as the process shown in FIGS. 5, 6, 7, and 9, the transport task may be switched to a “patrol cleaning task” in which both patrol and cleaning are performed. In addition, for example, the patrol cleaning task may be mainly performed as the patrol task, and the cleaning task may be performed incidentally when the automatic traveling vehicle travels along a predetermined patrol route. On the contrary, for example, the patrol cleaning task may be mainly performed as the cleaning task, and the patrol task may be performed incidentally when the automatic traveling vehicle travels along a predetermined cleaning route. Furthermore, the patrol cleaning task may be performed, for example, such that the automatic traveling vehicle travels both a predetermined patrol route and a predetermined cleaning route.

Additionally, the example in which the vehicle 90 provided with the cleaning device 94 performs the transport task and the cleaning task (or the patrol cleaning task) has been described here. However, in another example of the “automatic traveling vehicle” according to the present disclosure, a vehicle body without a cleaning device (for example, the vehicle body 14 shown in FIG. 1) may be used when performing the transport task, and a vehicle body equipped with a cleaning device (for example, the vehicle body 92 shown in FIG. 8) may be used when performing the cleaning task (or the patrol cleaning task). More specifically, the automatic traveling vehicle may return to a designated storage location once when performing the cleaning task (or the patrol cleaning task), and perform the cleaning task (or the patrol cleaning task) after the vehicle body is replaced by a worker with a vehicle body equipped with a cleaning device.

### 2. Second Embodiment

In a second embodiment, the processing and operation performed by the automatic traveling vehicle 10 or by the vehicle 10 and the management server 82 during the execution of the patrol task will be described. In the following description, the patrol task will be described as an example, but the same processing and operation may also be performed in the patrol cleaning task accompanied by the cleaning task.

### 2-1. Responding to Abnormal Situations During Patrol Task

As shown in FIG. 1 described above, the vehicle 10 includes the emergency button 26, the buzzer 22, and the abnormality warning lamp 24, as well as the cameras 56 that photograph the surroundings of the vehicle 10. Some abnormal situation such as a criminal act may occur around the vehicle 10 in which the patrol task is being executed. The emergency button 26 is operated, for example, by a user of the vehicle 10 who has encountered an abnormal situation. Moreover, it is assumed that not only the user but also a passerby who has encountered an abnormal situation operates the emergency button 26 of the vehicle 10.

In the second embodiment, when the emergency button 26 is operated, the processor 64a of the automatic travel ECU 64 operates the buzzer 22 and the abnormality warning lamp 24. When the buzzer 22 is operated, a loud noise is generated. Further, when the emergency button 26 is operated, the abnormality warning lamp 24 is, for example, blinked for alarm display. As a result, it is possible to widely inform the surroundings of the vehicle 10 of the abnormal situation. It should be noted that the buzzer 22 and the abnormality warning lamp 24 correspond to an example of the “first alarm device” according to the present disclosure. As the first alarm device, the vehicle 10 may be provided with either one of the buzzer 22 and the abnormality warning lamp 24, or may be provided with other alarm devices other than these.

Furthermore, in the second embodiment, when the emergency button 26 is operated, the processor 64a records an image photographed by the camera 56 and transmits the image to the management server 82. In addition, unlike the example described above, only one of recording and transmission of the image may be executed.

FIG. 10 is a flowchart showing an example of processing related to response to an abnormal situation during the patrol task according to the second embodiment. The processing of this flowchart is repeatedly executed by the processor 64a during the execution of the patrol task. It should be noted that this processing may be executed by a dedicated processor other than the processor 64a for the automatic travel control.

In FIG. 10, first, in step S200, the processor 64a determines whether or not the emergency button 26 is operated. As a result, when there is no operation of the emergency button 26, the processor 64a ends the current processing cycle.

On the other hand, when the emergency button 26 is operated in step S200, the process proceeds to step S202. In step S202, the processor 64a operates the buzzer 22 and the abnormality warning lamp 24 for a predetermined time. Thereafter, the processing proceeds to step S204.

In step S204, the processor 64a records an image of the surroundings of the vehicle 10 photographed by the cameras 56 (for example, the processor 64a stores the image in the storage device 64b). Then, in step S206, the processor 64a transmits the photographed image to the management server 82 via the communication device 60.

### 2-2. Effect

As described above, according to the second embodiment, when the emergency button 26 is operated, the buzzer 22 and the abnormality warning lamp 24 is operated. The vehicle 10 including the cameras 56, the emergency button 26, the buzzer 22, and the abnormality warning lamp 24 is traveling in the city or town, whereby the user of the vehicle 10 or a passerby near the vehicle 10 who has encountered an abnormal situation can widely inform the surroundings of the vehicle 10 of the abnormal situation by operating the emergency button 26.

Moreover, when the emergency button 26 is operated, recording of an image photographed by the camera 56 is performed in the vehicle 10. This makes it possible to provide evidence of an abnormal situation (for example, criminal activity) that has occurred. Furthermore, when the emergency button 26 is operated, the photographed image is transmitted to the management server 82. As a result, information on the abnormal situation can be promptly provided to the observer in the management facility in which the management server 82 is installed.

### 2-3. Other Examples of Response to Abnormal Situation

### 2-3-1. Example of Using Alarm Device on Infrastructure Side

As described above with reference to FIG. 4, in the example in which the buzzers 76 and the abnormality warning lamps 78 are installed along the roadside of the operating area of the vehicle 10, these buzzers 76 and the abnormality warning lamps 78 may be used for responding to an abnormal situation. In addition, the buzzers 76 and the abnormality warning lamps 78 correspond to examples of the “second alarm device” according to the present disclosure.

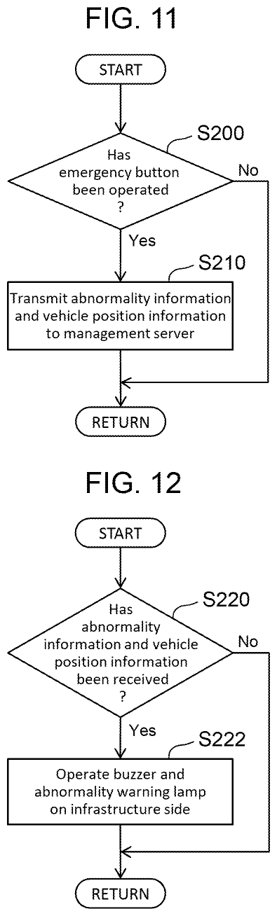

FIGS. 11 and 12 are flowcharts showing a modified example of processing related to response to an abnormal situation during the patrol task according to the second embodiment. More specifically, the processing shown in FIG. 11 is repeatedly executed by the processor 64a on the vehicle 10 side. On the other hand, the processing shown in FIG. 12 is repeatedly executed by the processor 82a on the side of the management server 82.

First, in FIG. 11, when the emergency button 26 is operated in step S200, the processing proceeds to step S210. In step S210, the processor 64a transmits, to the management server 82, the abnormality information indicating the occurrence of the abnormal situation detected in response to the operation of the emergency button 26 and the position information of the vehicle 10.

Then, in FIG. 12, first, in step S220, the processor 82a determines whether or not the management server 82 has received the abnormality information and the position information of the vehicle 10 from the vehicle 10. As a result, when the management server 82 has not yet received the abnormality information and the vehicle position information, the processor 82a ends the current processing cycle.

On the other hand, when the management server 82 receives the abnormality information and the vehicle position information in step S200, the processing proceeds to step S222. In step S222, the processor 82a operates the buzzer 76 and the abnormality warning lamp 78 on the infrastructure side. More specifically, the processor 82 operates the buzzer 76 and the abnormality warning lamp 78 located near the vehicle 10 for a predetermined time, based on the received vehicle position information.

According to the example shown in FIGS. 11 and 12, the vehicle 10 including the emergency button 26 and the position information acquisition device (e.g., GNSS receiver 62) is traveling in the city or town, whereby the abnormal situation that has occurred can be widely informed to the surroundings of the vehicle 10 by using the buzzers 76 and the abnormality warning lamps 78 on the infrastructure side.

### 2-3-2. Another Example of Method of Determining Abnormal Situation

As shown in FIG. 1 described above, the vehicle 10 includes the microphone 28. Therefore, the processor 64a may determine that an abnormal situation has occurred around the vehicle 10 when a predetermined password issued by the user of the vehicle 10 or a passerby near the vehicle 10 is detected.

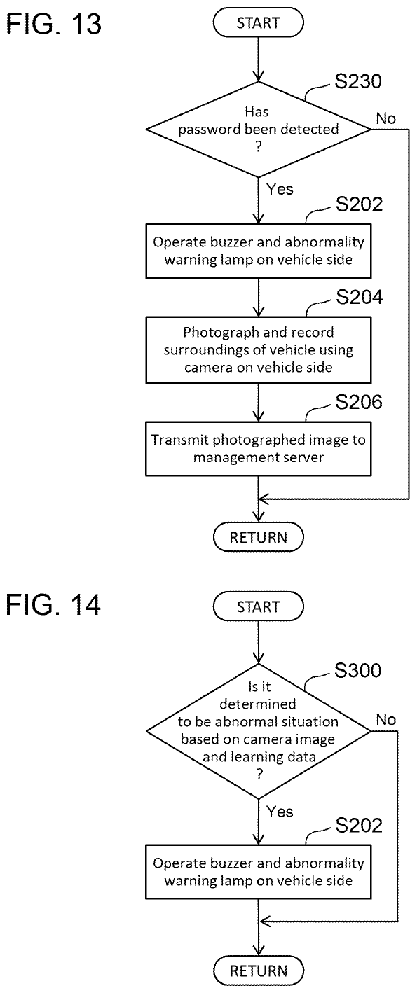

FIG. 13 is a flowchart showing another modified example of processing related to response to an abnormal situation during the patrol task according to the second embodiment. The processing of this flowchart is the same as the flowchart shown in FIG. 10 except that step S200 is replaced with step S230.

In FIG. 13, first, the processor 64a determines in step S230 whether or not a predetermined password has been detected by using the microphone 28. The password described here is, for example, “help” or “scream”. When this kind of password is detected, the processing of step S202 and the subsequent steps is executed. In addition, instead of the above-described processing of step S200 in FIG. 11, the processing of step S230 may be executed.

### 3. Third Embodiment

In a third embodiment, the processing and operation performed by the automatic traveling vehicle 10 during the execution of the patrol task will be described. In the following description, the patrol task will be described as an example, but the same processing and operation may also be performed in the patrol cleaning task accompanied by the cleaning task.

### 3-1. Response to Abnormal Situation During Patrol Task

In the third embodiment, in order to determine whether or not an abnormal situation has occurred around the vehicle 10, a processor (for example, the processor 64a) mounted on the vehicle 10 executes the following abnormal situation determination process using an image recognition function. The storage device 64b stores an image recognition program using machine learning, and the processor 64a executes the abnormal situation determination process by executing the image recognition program.

More specifically, in the abnormal situation determination process, the processor 64a determines whether or not an abnormal situation has occurred around the vehicle 10, based on the images photographed by the cameras 56 and the learning data of the images showing the abnormal situation.

Then, in the third embodiment, the processor 64a operates the buzzer 22 and the abnormality warning lamp 24 when it is determined by the abnormal situation determination process that an abnormal situation has occurred.

FIG. 14 is a flowchart showing an example of processing related to response to an abnormal situation during the patrol task according to the third embodiment. The processing of this flowchart is the same as the flowchart shown in FIG. 10 except that step S200 is replaced with step S300.

In FIG. 14, first, in step S300, the processor 64a executes the abnormal situation determination process described above. Specific examples of abnormal situations learned in advance for this determination include that a person is lying down along the road, that there is a person with a weapon, and that there is a suspicious person in behavior. In addition, in an example in which the operating area of the vehicle 10 is a facility where strict confidentiality management is performed, the fact that there is a person having shooting equipment such as a camera is also included in the specific examples of the learned abnormal situations.

In step S300, when the processor 64a determines (detects) an abnormal situation from the images of the camera 56 based on the learning data, the processing proceeds to step S202 (see FIG. 10), and the processor 64a operates the buzzer 22 and the abnormality warning lamp 24.

### 3-2. Effect

According to the third embodiment described above, the automatic traveling vehicle 10 (processor 64a) itself can determine an abnormal situation from the images of the camera 56 based on the learning data, and take measures against the abnormal situation (i.e., widely inform the surroundings of the vehicle 10 of the abnormal situation that has occurred).

### 3-3. Examples of Other Measures Against Abnormal Situation

The processor 64a may use the determination result of the abnormal situation by the abnormal situation determination process described above to take the following measures against the abnormal situation.

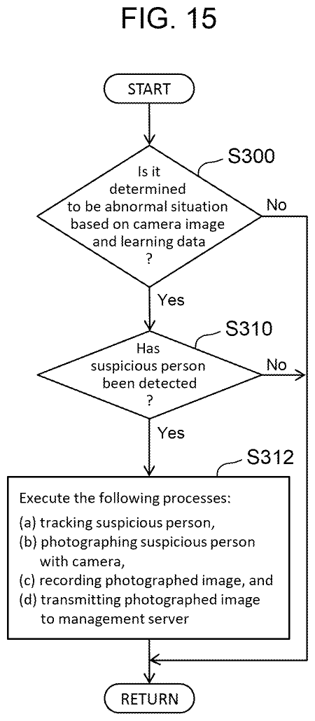

FIG. 15 is a flowchart showing a modified example of processing related to response to an abnormal situation during the patrol task according to the third embodiment. The processing of this flowchart will be described focusing on the differences from the flowchart shown in FIG. 14.

In FIG. 15, when the processor 64a determines in step S300 that an abnormal situation has occurred, the processing proceeds to step S310. In step S310, the processor 64a determines whether or not a suspicious person has been detected by the abnormal situation determination process in step S300. Specifically, the processor 64a determines whether or not the abnormal situation determined by the abnormal situation determination process indicates that a suspicious person exists around the vehicle 10. When the abnormal situation determined in step S300 indicates, for example, that there is a person who has a weapon, there is a suspicious person in behavior, or there is a person who has shooting equipment, it is determined that there is a suspicious person around the vehicle 10.

When no suspicious person is detected in step S310, the processor 64a ends the current processing cycle. Alternatively, when no suspicious person is detected in step S310, the processor 64a may execute the above-described processing of step S202 (i.e., operation of at least one of the buzzer 22 and the abnormality warning lamp 24).

On the other hand, when a suspicious person is detected in step S310, the processing proceeds to step S312. In step S312, the processor 64a controls the travel of the vehicle 10 so as to track the suspicious person, photographs the suspicious person using the camera 56, and records the photographed image of the suspicious person and transmits the image to the management server 82. More specifically, the travel control of the vehicle 10 for tracking the suspicious person can be performed, for example, by using the camera 56 or the LIDAR 58 to control the electric motors 36 such that the vehicle 10 keeps a constant distance from the suspicious person.

Additionally, instead of the processing of step S312, only one of recording the image of the suspicious person photographed by the camera 56 and transmitting the image to the management servers 82 may be executed.

According to the above-described countermeasure example shown in FIG. 15, the automatic traveling vehicle 10 (the processor 64a) itself can determine an abnormal situation from the image of the camera 56 based on the learning data, and provide more active security to the suspicious person as compared with the countermeasure example shown in FIG. 14.

Moreover, the processor 64a may use the determination result of the abnormal situation by the above-described abnormal situation determination process to take the following measures against the abnormal situation.

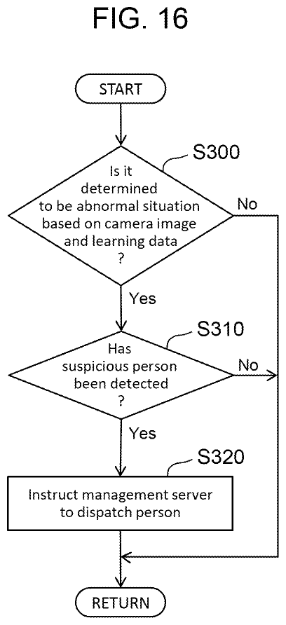

FIG. 16 is a flowchart showing another modified example of processing related to response to an abnormal situation during the patrol task according to the third embodiment. The processing of this flowchart will be described focusing on the differences from the flowchart shown in FIG. 15.

In FIG. 15, when a suspicious person is detected in step S310, the processing proceeds to step S320. In step S320, the processor 64a transmits the position information of the vehicle 10 to the management server 82 and requests the management server 82 to dispatch a person to the place where the abnormal situation has occurred.

According to the above-described countermeasure example shown in FIG. 16, the automatic traveling vehicle 10 (the processor 64a) itself can determine an abnormal situation from the image of the camera 56 based on the learning data, and strengthen security against suspicious persons.

Additionally, the countermeasure examples shown in FIGS. 14, 15, and 16 may be implemented in combination as appropriate.

### 4. Fourth Embodiment

In a fourth embodiment, specific examples of the method of generating a patrol route used during the execution of the patrol task will be described. In the following description, the patrol task will be described as an example, but the patrol route similarly generated may also be used in the patrol cleaning task accompanied by the cleaning task.

### 4-1. Method of Generating Patrol Route (Using Illuminance Sensor)

As described above with reference to FIG. 3, a plurality of illuminance sensors 72 are densely installed in the operating area of the vehicle 10. As described above, the management server 82 can communicate with the plurality of illuminance sensors 72. The method of generating the patrol route described here is performed by using the plurality of illuminance sensors 72 for nighttime.

Specifically, at night, the brightness of roads and roadsides in the operating area may vary from place to place. Therefore, in the fourth embodiment, when the patrol task is executed at night, the patrol route is generated such that the vehicle 10 sequentially passes through a plurality of spots with relatively low illuminance in the operating area.

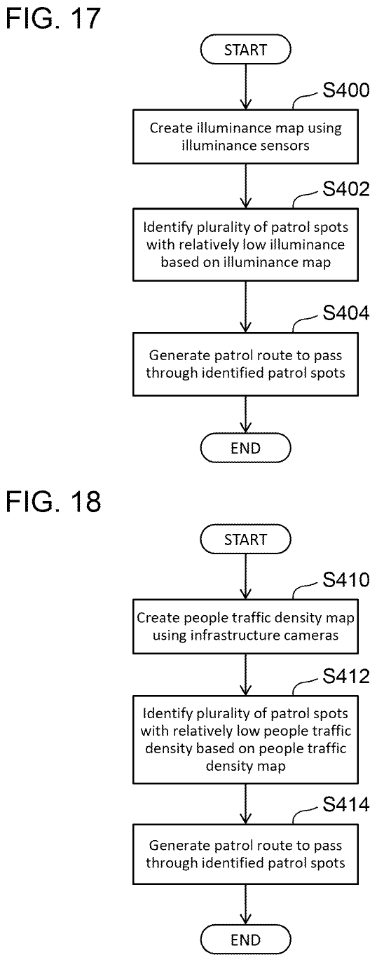

FIG. 17 is a flowchart showing an example of processing related to the generation of the patrol route according to the fourth embodiment. The processing of this flowchart is executed by the processor 82a on the side of the management server 82 prior to the start of the patrol task, for example. In addition, as described above, the vehicle 10 can also communicate with the plurality of illuminance sensors 72. For this reason, the generation of this patrol route may be performed by the processor 64a on the vehicle 10 side.

In FIG. 17, first, in step S400, the processor 82a creates an illuminance map using the plurality of illuminance sensors 72. Specifically, the processor 82a acquires the position information and illuminance information of each spot in the operating area from the plurality of illuminance sensors 72 densely installed in the operating area. Then, the processor 82a creates an illuminance map by associating the acquired position information and illuminance information of each spot with the map of the operating area stored in the storage device 82b. Thereafter, the processing proceeds to step S402.

In step S402, based on the created illuminance map, the processor 82a identifies a plurality of patrol spots with relatively low illuminance on the map. More specifically, the plurality of patrol spots with relatively low illuminance can be identified, for example, by extracting a plurality of spots having an illuminance of a predetermined value or less. Thereafter, the processing proceeds to step S404.

In step S404, the processor 82a generates a patrol route such that the vehicle 10 sequentially passes through the identified plurality of patrol spots.

### 4-2. Effect

According to the method of generating the patrol route described above, the vehicle 10 can patrol a relatively dark road with priority when performing the patrol task at night. It can be said that criminal acts are likely to occur on dark night roads. Therefore, according to this method of generating the patrol route, it is possible to provide a patrol service that can efficiently improve crime prevention.

### 4-3. Other Examples of Method of Generating Patrol Route

### 4-3-1. Method Based on People Traffic Density

As described above, the management server 82 can communicate with the plurality of infrastructure cameras 70 densely installed in the operating area. By counting the number of people in the images photographed by the plurality of infrastructure cameras 70, it is possible to grasp the number of people in each spot in the operating area. Therefore, in the method described next with reference to FIG. 18, the patrol route is generated in consideration of the density of traffic in the operating area.

FIG. 18 is a flowchart showing a modified example of processing related to the generation of the patrol route according to the fourth embodiment. The processing of this flowchart is executed by the processor 82a on the side of the management server 82 prior to the start of the patrol task, for example, in a patrol time zone in which the patrol task is scheduled to be executed. This patrol time zone is not limited to nighttime and can be appropriately determined. In addition, the generation method may be executed by the processor 64a on the vehicle 10 side that can communicate with the plurality of infrastructure cameras 70 similarly to the management server 82.

In FIG. 18, first, in step S410, the processor 82a creates a people traffic density map using the plurality of infrastructure cameras 70. Specifically, the processor 82a acquires the position information of each spot and the information indicating the number of people passing by in the operating area from the images of the plurality of infrastructure cameras 70 densely installed in the operating area. More specifically, for example, the integrated value obtained by integrating the number of people in each image while updating the images of the infrastructure cameras 70 at predetermined time intervals (e.g., 5 minutes) for the above-described patrol time zone corresponds to the information indicating the number of people passing by. The processor 82a then creates a people traffic density map by associating the acquired position information of each spot and information indicating the number of people passing by, with the map of the operating area stored in the storage device 82b. Thereafter, the processing proceeds to step S412.

In step S412, based on the created people traffic density map, the processor 82a identifies a plurality of patrol spots with relatively low people traffic density on the map. More specifically, the plurality of patrol spots with relatively low people traffic density can be identified, for example, by extracting a plurality of spots having a people traffic density of a predetermined value or less. Thereafter, the processing proceeds to step S414.

In step S414, the processor 82a generates a patrol route such that the vehicle 10 sequentially passes through the identified plurality of patrol spots.

According to the above-described method of generating the patrol route shown in FIG. 18, the vehicle 10 can patrol a relatively low people traffic road with priority. It can be said that criminal acts are likely to occur in low people traffic spots. Therefore, it is possible to provide a patrol service that can efficiently improve crime prevention even by this method of generating the patrol route.

### 4-3-2. Method of Randomly Generating Patrol Route

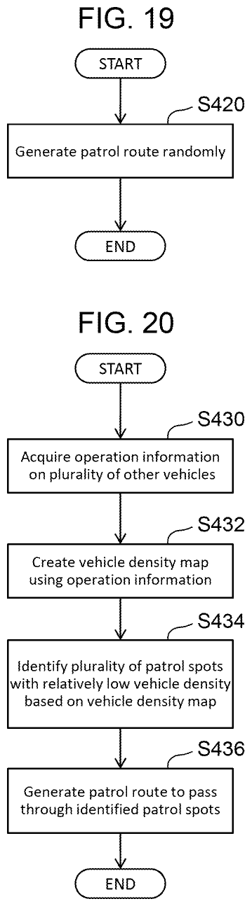

Next, FIG. 19 is a flowchart showing another modified example of processing related to the generation of the patrol route according to the fourth embodiment. The processing of this flowchart is executed, for example, by the processor 82a on the side of the management server 82 prior to the start of the patrol task, but may be executed by the processor 64a on the side of the vehicle 10.

In FIG. 19, the processor 82a randomly generates a patrol route in step S420. Specifically, the storage device 82b stores a program for randomly generating a travel route of the vehicle 10. The processor 82a randomly generates a patrol route so as to be a different route each time the patrol task is executed, for example, by executing this kind of program.

If the time that the vehicle 10 patrols is always the same, the criminal may commit a crime by aiming at the time zone in which the vehicle 10 does not appear. On the other hand, by randomly generating the patrol route according to the above-described method shown in FIG. 19, it becomes difficult to commit a crime at a time zone in which the patrol is thin. Therefore, crime prevention can be improved.

### 4-3-4. Method Based on Vehicle Density

As described above, the management server 82 can acquire the operation information 74 (see FIG. 4) of a plurality of other vehicles traveling in the operating area. Therefore, the method of generating the patrol route, which will be described next with reference to FIG. 20, is performed in consideration of the density of vehicles in the operating area based on the operation information 74.

FIG. 20 is a flowchart showing still another modified example of processing related to the generation of the patrol route according to the fourth embodiment. The processing of this flowchart is executed, for example, by the processor 82a on the side of the management server 82 prior to the start of the patrol task, but may be executed by the processor 64a on the side of the vehicle 10.

In FIG. 20, first, in step S430, the processor 82a acquires the operation information (for example, position information) 74 of a plurality of other vehicles. Thereafter, the processing proceeds to step S432, and the processor 82a creates a vehicle density map using the acquired operation information 74. Specifically, the processor 82a creates a vehicle density map by associating the acquired position information of other vehicles traveling in each spot, with the map of the operating area stored in the storage device 82b. Thereafter, the processing proceeds to step S434.

In step S434, based on the created vehicle density map, the processor 82a identifies, on the map, a plurality of patrol spots with relatively low vehicle density. More specifically, the plurality of patrol spots with relatively low vehicle density can be identified, for example, by extracting a plurality of spots having a vehicle density of a predetermined value or less. Thereafter, the processing proceeds to step S436.

In step S436, the processor 82a generates a patrol route such that the vehicle 10 sequentially passes through the identified plurality of patrol spots.

According to the method of generating the patrol route shown in FIG. 20 described above, the vehicle 10 can preferentially patrol the road having a relatively low vehicle traffic. It can be said that the criminal acts are likely to occur in spots with low vehicle traffic. Therefore, it is possible to provide a patrol service that can efficiently improve crime prevention even by this method of generating the patrol route.

### 5. Fifth Embodiment

In a fifth embodiment, a specific example of the cleaning task set by the management server 82 will be described. In the following description, the cleaning task will be described as an example, but the same processing may be executed in the patrol cleaning task accompanied by the patrol task.

### 5-1. Specific Setting Example of Cleaning Task

In the fifth embodiment, as a premise, it is assumed that the vehicle 10 performs the transport task in the above-described time zone TZ1 (daytime) and performs the cleaning task in the above-described time zone TZ3 (nighttime). Also, it is assumed that, when performing the cleaning task after completing the transport task, the vehicle 10 once returns to a designated storage location, and the vehicle body of the vehicle 10 is replaced from the vehicle body 14 (see FIG. 1) having no cleaning device to the vehicle body 92 (see FIG. 8) having the cleaning device 94. In addition, when the vehicle body is replaced in this way, the vehicle 10 becomes the same as the vehicle 90 shown in FIG. 8. Therefore, in the following description, the vehicle 10 when performing the cleaning task is referred to as the vehicle 90.

The vehicle 10 is equipped with the cleaning request button 29 (see FIG. 1) operated by the user on board. When the vehicle 10 is executing the transport task in the daytime, the processor 64a transmits information on a cleaning request position P, which is the position of the vehicle 10 when the cleaning request button 29 is operated by the user, to the management server 82.

The processor 82a on the management server 82 side which has received the information on the cleaning request position P from the vehicle 10 performs the task management for cleaning the cleaning request position P at night. Specifically, the processor 82a which manages the operation of a plurality of automatic traveling vehicles 10 having the same configuration selects one vehicle 90 heading for the cleaning request position P at night (time zone TZ3) for cleaning (i.e., the vehicle 10 provided with the cleaning device 94), from among the plurality of vehicles 10 including the vehicle 10 that transmitted the information on the cleaning request position P to the management server 82 in the daytime. Then, the processor 82a gives the selected vehicle 10 a cleaning task to clean the cleaning request position P.

Additionally, the transmission of the cleaning request position P by the operation of the cleaning request button 29 can be performed from a plurality of vehicles 10 performing the transport task in the daytime. It is also assumed that the cleaning request button 29 is operated at a plurality of spots during the execution of the transport task of one vehicle 10. For this reason, basically, there are a plurality of cleaning request positions P. Then, in an example in which the cleaning request positions P are plural, one vehicle 90 given the cleaning task by the processor 82a will clean the plurality of cleaning request positions P at night.

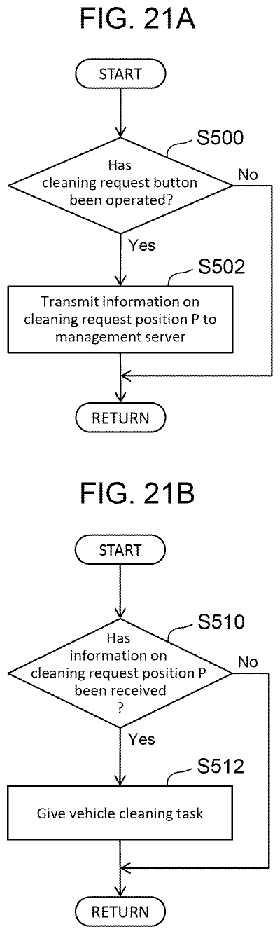

FIG. 21A is a flowchart showing an example of processing executed during the execution of the transport task in the daytime according to the fifth embodiment. The processing of this flowchart is executed by the processor 64a on the side of the vehicle 10.

In FIG. 21A, first, in step S500, the processor 64a determines whether or not the cleaning request button 29 is operated. As a result, when the cleaning request button 29 is not operated, the processor 64a ends the current processing cycle.

On the other hand, when the cleaning request button 29 is operated in step S500, the processing proceeds to step S502. In step S502, the processor 64a transmits, to the management server 82, information on the position of the vehicle 10 when the cleaning request button 29 is operated (i.e., the cleaning request position P).

Then, FIG. 21B is a flowchart showing an example of processing related to setting the cleaning task in the nighttime according to the fifth embodiment. The processing of this flowchart is executed by the processor 82a on the side of the management server 82.

In FIG. 21B, first, in step S510, the processor 82a determines whether or not the information on the cleaning request position P has been received from the vehicle 10 in which the transport task is being executed. As a result, when the information on the cleaning request position P has not been received, the processor 82a ends the current processing cycle.

On the other hand, when the information on the cleaning request position P is received in step S510, the processing proceeds to step S512. In step S512, the processor 82a gives a cleaning task to the vehicle 10 that has transmitted the information on the cleaning request position P or another vehicle 10 so as to clean the cleaning request position P at night.

### 5-2. Effect

As described above, according to the fifth embodiment, even when the user who is riding on the vehicle performing the transport task finds a spot to be cleaned in the daytime, cleaning of this spot is not performed in the daytime but is performed in the nighttime. As a result, the people traffic is not obstructed by performing the cleaning in the daytime when it is expected that there is a lot of people traffic. Moreover, in the daytime, it is highly possible that the operating rate of the vehicle 10 is high due to the execution of the transport task. Therefore, by only transmitting the cleaning request position P to the management server 82 in the daytime and performing the cleaning in the nighttime, the operating rate of the vehicle 10 can be leveled between the daytime and the nighttime. Furthermore, since the cleaning of a plurality of cleaning request positions P can be performed by one vehicle 90 in the nighttime, the cleaning task can be efficiently performed. In addition, the user who boarded the vehicle 10 in the daytime can actively cooperate in promoting the beautification of the city or town.

### 6. Sixth Embodiment

In a sixth embodiment, specific examples of the method of generating a cleaning route used during the execution of the cleaning task will be described. In the following description, the cleaning task will be described as an example, but a similarly generated cleaning route may also be used in the patrol cleaning task accompanied by the patrol task.

### 6-1. Method of Generating Cleaning Route (Considering People Traffic in Daytime)

According to the method of generating the cleaning route in the sixth embodiment, the processor 82a on the management server 82 side uses the plurality of infrastructure cameras 70 to identify one or more cleaning spots with relatively high people traffic density in the daytime in the operating area, and records the one or more cleaning spots. Then, when the vehicle 10 performs the cleaning task in the nighttime, the processor 82a generates a cleaning route such that the vehicle 10 sequentially passes through the one or more cleaning spots. In addition, the nighttime when the cleaning task is performed using the cleaning route generated in this way is basically the same day as the daytime when the one or more cleaning spots are identified.

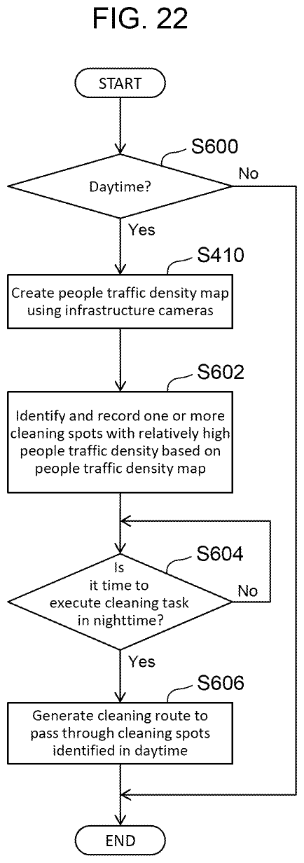

FIG. 22 is a flowchart showing an example of processing related to the generation of the cleaning route according to the sixth embodiment. The processing of this flowchart is repeatedly executed by the processor 82a on the side of the management server 82, but may be executed by the processor 64a on the side of the vehicle 10.

In FIG. 22, first, in step S600, the processor 82a determines whether or not the current time zone is daytime. As a result, when the determination result is negative, the processor 82a ends the current processing cycle.

On the other hand, when the determination result of step S600 is positive, the processing proceeds to step S410, and the processor 82a creates a people traffic density map using the plurality of infrastructure cameras 70 as described above with reference to FIG. 18. Thereafter, the processing proceeds to step S602.

In step S602, based on the created people traffic density map, the processor 82a identifies one or more cleaning spots with relatively high people traffic density on the map, and records the one or more cleaning spots. More specifically, one or more cleaning spots with relatively high people traffic density can be identified, for example, by extracting one or more spots having a people traffic density of a predetermined value or more. The processor 82a stores the identified one or more cleaning spots in the storage device 82b. Thereafter, the processing proceeds to step S604.

In step S604, the processor 82a determines whether or not it is time to execute the nighttime cleaning task. As a result, when it is time to execute the nighttime cleaning task, the processing proceeds to step S606.

In step S606, the processor 82a generates a cleaning route such that the vehicle 10 passes through the one or more cleaning spots identified in the daytime.

### 6-2. Effect

According to the method of generating the cleaning route according to the sixth embodiment described above, spots with a relatively high people traffic density in the daytime can be preferentially cleaned by the vehicle 90 (i.e., the vehicle 10 equipped with the cleaning device 94) at night. It can be said that spots with a high people traffic density in the daytime are more likely to be dusty or dirty than spots with a low people traffic density. Therefore, according to this method of generating the cleaning route, it is possible to provide an efficient cleaning service.

### 6-3. Another Example of Method of Generating Cleaning Route (Use of Past Cleaning Data)

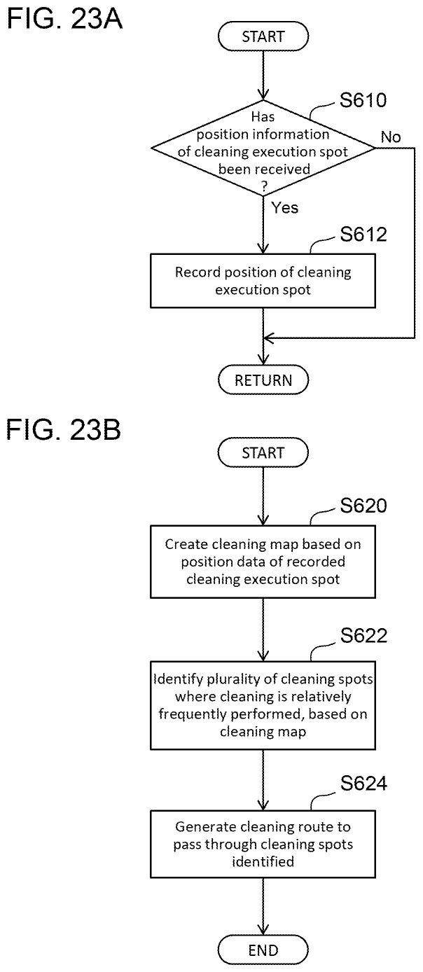

In the method described below, the cleaning route is generated based on past cleaning data by a plurality of automatic traveling vehicles 90. The generation of the cleaning route by this method is realized by the following combination of the processing of flowcharts of FIGS. 23A and 23B.

FIG. 23A is a flowchart showing a modified example of processing related to the generation of the cleaning route according to the sixth embodiment. The processing of this flowchart is repeatedly executed by the processor 82a on the side of the management server 82.

In FIG. 23A, first, in step S610, the processor 82a determines whether or not the position information of the cleaning execution spot has been received from a plurality of vehicles 90 that perform the cleaning task in the operating area. The position of the cleaning execution spot is the position of the vehicle 90 acquired by using the GNSS receiver 62.

When the position information of the cleaning execution spot has not been received in step S610, the processor 82a ends the current processing cycle. On the other hand, when the position information of the cleaning execution spot is received, the processing proceeds to step S612. In step S612, the processor 82a records the position of the received cleaning execution spot (e.g., stores the position of the received cleaning execution spot in the storage device 82b).

The processor 82a records the position of the cleaning execution spot by the processing of the flowchart shown in FIG. 23A each time the plurality of vehicles 90 traveling in the operating area perform cleaning in the cleaning task. By repeating this kind of processing, the position data of the past cleaning execution spots (i.e., past cleaning data) is accumulated.

Then, FIG. 23B is a flowchart showing the modified examples of processing related to the generation of the cleaning route according to the sixth embodiment. The processing of this flowchart is repeatedly executed by the processor 82a on the side of the management server 82, but may be executed by the processor 64a on the side of the vehicle 90.

In FIG. 23B, first, in step S620, the processor 82a creates a cleaning map based on the position data (the past cleaning data) of the cleaning execution spots recorded by the processing of the flowchart shown in FIG. 23A. Specifically, the processor 82a creates a cleaning map by associating the position data of the recorded cleaning execution spots with the map of the operating area stored in the storage device 82b. More specifically, in this cleaning map, when the same spot is cleaned multiple times, the number of position data associated with the spot increases. Thereafter, the processing proceeds to step S622.

In step S622, based on the created cleaning map, the processor 82a identifies, on the map, a plurality of cleaning spots where cleaning is relatively frequently performed. More specifically, the plurality of cleaning spots can be identified, for example, by extracting a plurality of spots in which the number of position data accumulated each time cleaning is equal to or greater than a predetermined value. Thereafter, the processing proceeds to step S624.

In step S624, the processor 82a generates a cleaning route such that the vehicle 90 sequentially passes through the identified plurality of cleaning spots.

According to the method of generating the cleaning route shown in FIGS. 23A and 23B described above, by using the history (so-called big data) of cleaning performed by the plurality of vehicles 90, it becomes possible to focus on cleaning spots where dust easily collects or becomes dirty. Therefore, it is possible to provide an efficient cleaning service also by this method of generating the cleaning route.

### 7. Other Embodiments

When the patrol task is performed using a plurality of automatic traveling vehicles 10, the management server 82 may deploy each vehicle 10 in the operating area in the following manner. That is, the management server 82 may disperse and deploy the vehicles 10 so as to cover a plurality of spots in which crimes have occurred, for example, based on data of crime cases that have occurred in the past in the operating area. Moreover, the management server 82 may deploy the vehicles 10 in the operating area such that, for example, the total distance between the vehicles 10 is the largest (i.e., the vehicles 10 are evenly distributed). Furthermore, the management server 82 may deploy the vehicles 10 in the operating area such that, for example, the total distance between each of the plurality of infrastructure cameras 70 installed in the operating area and each of the plurality of vehicles 10 is the largest. As a result, the in-vehicle cameras 56 and the infrastructure cameras 70 can be evenly deployed in the operating area. That is, the in-vehicle cameras 56 and the infrastructure cameras 70 can be centrally managed and used for crime prevention.

What is claimed is:

1. An operation management system, comprising:
an automatic traveling vehicle including a first processor, and configured to transport at least one of people or luggage; and
a management server including a second processor, and configured to communicate with the automatic traveling vehicle and manage an operation of the automatic traveling vehicle, wherein
the first processor or the second processor is configured to:
determine whether or not there is a transport task in which the automatic traveling vehicle transports at least one of people or luggage; and
when there is no transport task, execute a task switching process of causing the automatic traveling vehicle to execute any one of a patrol task in which the automatic traveling vehicle performs a patrol of an operating area of the automatic traveling vehicle, a cleaning task in which the automatic traveling vehicle performs a cleaning of the operating area, and a patrol cleaning task in which the automatic traveling vehicle performs both the patrol and the cleaning.

2. The operation management system according to claim 1, wherein
in the task switching process, the first processor or the second processor is configured to switch from the transport task to any one of the patrol task, the cleaning task, and the patrol cleaning task when a time zone without the transport task arrives.

3. The operation management system according to claim 1, wherein
in the task switching process, the first processor or the second processor is configured to switch from the transport task to any one of the patrol task, the cleaning task, and the patrol cleaning task when a latest transport task has been completed and a next transport task has not been accepted.

4. The operation management system according to claim 1, wherein
the automatic traveling vehicle includes:
an in-vehicle camera configured to photograph surroundings of the automatic traveling vehicle;
an emergency button configured to be operated when an abnormal situation occurs around the automatic traveling vehicle; and
a first alarm device, and
in the patrol task or the patrol cleaning task, the first processor is configured to operate the first alarm device and execute at least one of recording an image photographed by the in-vehicle camera and transmitting the image to the management server when the emergency button is operated.

5. The operation management system according to claim 1, wherein
the automatic traveling vehicle includes:
an emergency button configured to be operated when an abnormal situation occurs around the automatic traveling vehicle; and
a position information acquisition device configured to acquire position information of the automatic traveling vehicle,
the management server is configured to communicate with a second alarm device installed in the operating area,
in the patrol task or the patrol cleaning task, the first processor is configured to transmit abnormality information indicating an occurrence of the abnormal situation and the position information to the management server when the emergency button is operated, and
the second processor is configured to operate the second alarm device located around the automatic traveling vehicle when the management server receives the abnormality information and the position information.

6. The operation management system according to claim 1, wherein
the automatic traveling vehicle includes a microphone, and
in the patrol task or the patrol cleaning task, the first processor is configured to determine that an abnormal situation has occurred around the automatic traveling vehicle when the first processor detects a predetermined password using the microphone.

7. The operation management system according to claim 1, wherein
the automatic traveling vehicle includes an in-vehicle camera configured to photograph surroundings of the automatic traveling vehicle, and
in the patrol task or the patrol cleaning task, the first processor is configured to execute an abnormal situation determination process of determining whether or not an abnormal situation has occurred around the automatic traveling vehicle, based on an image photographed by the in-vehicle camera and learning data of images showing the abnormal situation.

8. The operation management system according to claim 7, wherein
the automatic traveling vehicle includes a first alarm device, and
the first processor is configured to operate the first alarm device when the abnormal situation determination process determines that the abnormal situation has occurred.

9. The operation management system according to claim 7, wherein
the first processor is configured, when the abnormal situation determined by the abnormal situation determination process indicates that there is a suspicious person around the automatic traveling vehicle, to:
control travel of the automatic traveling vehicle so as to track the suspicious person;
photograph the suspicious person using the in-vehicle camera; and
execute at least one of recording a photographed image of the suspicious person and transmitting the photographed image to the management server.

10. The operation management system according to claim 7, wherein
the automatic traveling vehicle includes a position information acquisition device configured to acquire position information of the automatic traveling vehicle, and
the first processor is configured, when the abnormal situation determined by the abnormal situation determination process indicates that there is a suspicious person around the automatic traveling vehicle, to transmit the position information to the management server and request the management server to dispatch a person to a place where the abnormal situation has occurred.

11. The operation management system according to claim 1, wherein
the automatic traveling vehicle or the management server is configured to communicate with a plurality of illuminance sensors installed in the operating area, and
the first processor or the second processor is configured, when executing the patrol task or the patrol cleaning task in a nighttime, to generate a patrol route such that the automatic traveling vehicle sequentially passes through a plurality of patrol spots with low illuminance in the operating area.

12. The operation management system according to claim 1, wherein
the automatic traveling vehicle or the management server is configured to communicate with a plurality of infrastructure cameras installed in the operating area, and
the first processor or the second processor is configured to:
identify, using the plurality of infrastructure cameras, a plurality of spots with low traffic density in the operating area in a patrol time zone in which the patrol task or the patrol cleaning task is executed; and
generate a patrol route such that the automatic traveling vehicle sequentially passes through the plurality of spots when executing the patrol task or the patrol cleaning task in the patrol time zone.

13. The operation management system according to claim 1, wherein
the first processor or the second processor is configured to randomly generate a patrol route so as to become different each time the patrol task or the patrol cleaning task is executed.

14. The operation management system according to claim 1, wherein
the automatic traveling vehicle or the management server is configured to communicate with a plurality of other vehicles, which are other than the automatic traveling vehicle and travel the operating area, and
the first processor or the second processor is configured to:
acquire operation information of the plurality of other vehicles; and
generate, based on the operation information, a patrol route such that the automatic traveling vehicle sequentially passes through a plurality of patrol spots with low density of vehicles traveling in the operating area.

15. The operation management system according to claim 1, wherein
the automatic traveling vehicle includes:
a cleaning request button configured to be operated by a user on board; and
a position information acquisition device configured to acquire position information of the automatic traveling vehicle,
the first processor is configured to transmit, to the management server, information on a cleaning request position, which is a position of the automatic traveling vehicle when the cleaning request button is operated by the user, when the automatic traveling vehicle is executing the transport task in a daytime, and
the second processor is configured to give the cleaning task or the patrol cleaning task to the automatic traveling vehicle or another traveling vehicle having a same configuration as the automatic traveling vehicle to perform a cleaning of the cleaning request position in a nighttime.

16. The operation management system according to claim 1, wherein
the automatic traveling vehicle or the management server is configured to communicate with a plurality of infrastructure cameras installed in the operating area, and
the first processor or the second processor is configured to:
identify and record, using the plurality of infrastructure cameras, one or more cleaning spots with high people traffic density in a daytime in the operating area; and
generate a cleaning route such that the automatic traveling vehicle passes through the one or more cleaning spots when the automatic traveling vehicle performs the cleaning task or the patrol cleaning task in a nighttime.

17. The operation management system according to claim 1, wherein
the automatic traveling vehicle includes a position information acquisition device configured to acquire position information of the automatic traveling vehicle, and
the second processor is configured to:
record a position of a cleaning execution spot identified by the position information acquisition device each time the automatic traveling vehicle or another traveling vehicle having a same configuration as the automatic traveling vehicle performs a cleaning in the cleaning task or the patrol cleaning task; and
generate, based on position data of recorded cleaning execution spots, a cleaning route such that the automatic traveling vehicle or the another automatic traveling vehicle sequentially passes through a plurality of cleaning spots where cleaning is frequently performed in the operating area.
